(19) United States
(12) Patent Application Publication
(10) Pub. No.: US 2026/0072733 A1
(43) Pub. Date: Mar. 12, 2026

(54) ACCELERATED BOOTSTRAPPING FULLY HOMOMORPHIC ENCRYPTION CALCULATOR, COMPUTING SYSTEM, AND OPERATING METHOD THEREOF

(71) Applicants: INVENTEC (PUDONG) TECHNOLOGY CORPORATION, Shanghai (CN); INVENTEC CORPORATION, Taipei City (TW)

(72) Inventors: Yu HSIAO, Taipei City (TW); Yu-Te KU, Taipei City (TW); Ming-Chien HO, Taipei City (TW); Chih-Fan HSU, Taipei City (TW); Ming-Ching CHANG, Taipei City (TW); Wei-Chao CHEN, Taipei City (TW); Feng-Hao LIU, Taipei City (TW); Shih-Hao HUNG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/984,694

(22) Filed: Dec. 17, 2024

(30) Foreign Application Priority Data
Sep. 11, 2024 (CN) 202411275495.9

(51) Int. Cl. G06F 9/48; G06F 9/4401; H04L 9/00

(52) U.S. Cl. CPC G06F 9/4881; G06F 9/4401; H04L 9/008

(57) ABSTRACT

The accelerated bootstrapping fully homomorphic encryption calculator includes a memory, a controller, a task scheduler, a plurality of processing units, and a bus. The memory stores ciphertext structured as learning with errors over rings. The controller manages storing the ciphertext and generates instructions for bootstrapping. The task scheduler organizes tasks based on the controller's instructions, and the processing units decompose the ciphertext and perform computations to generate intermediate or final results. The bus connects all components and handles the transmission of ciphertext, instructions, and results.

### CROSS-REFERENCE TO RELATED APPLICATIONS

This non-provisional application claims priority under 35 U.S.C. § 119 (a) on Patent Application No(s). 202411275495.9 filed in China on Sep. 11, 2024, the entire contents of which are hereby incorporated by reference.

### BACKGROUND

### 1. Technical Field

The present disclosure relates to Fully Homomorphic Encryption (FHE), specifically to an accelerated bootstrapping FHE calculator, FHE computing system and operating method thereof.

### 2. Related Art

Fully Homomorphic Encryption (FHE) is an encryption technology that allows computations to be performed on encrypted data without the need to decrypt it, thereby protecting the privacy of sensitive data. This technology is significant in fields such as cloud computing and privacy protection, as it enables users to securely upload data to the cloud for processing without exposing the data content. Compared to traditional encryption techniques, FHE offers a higher level of security, ensuring that data remains protected throughout transmission and processing.

In practical applications, FHE faces performance challenges. Its high computational complexity leads to slower operation because performing calculations on encrypted data requires extensive mathematical operations, such as polynomial evaluation or matrix operations, which consume significant computational resources. Moreover, FHE may require a large amount of memory to handle large-scale data and increase communication costs during data transmission. Although FHE theoretically provides strong privacy protection, these performance issues limit its widespread adoption in real-world applications.

The third generation of FHE schemes (referred to as FHEW/TFHE) is suitable for processing integer data. This scheme enables highly efficient homomorphic computations in low-dimensional spaces with precise results. FHEW/TFHE offers low-cost data protection and is flexible and efficient in handling various data sizes. The ciphertext and key sizes in FHEW/TFHE are relatively small, making it especially suitable for hardware accelerators with limited memory. However, when processing large amounts of data, the efficiency of FHEW/TFHE may decrease, and the currently supported integer range is relatively small, such as int8, making it unsuitable for applications that require a broader data range.

Presently, hardware accelerators based on FHEW/TFHE face several challenges: Firstly, the settings of FHE parameters, such as the dimension/modulus of the polynomial ring and the base, are fixed or difficult to modify, resulting in poor flexibility, which makes it challenging to adjust the parameters for different privacy protection applications. Additionally, the acceleration strategies adopted by the accelerator are limited in scalability, supporting only a low parameter ceiling, which cannot meet the requirements for higher security levels or a broader range of applications.

### SUMMARY

In light of the above descriptions, the present disclosure proposes an accelerated bootstrapping FHE calculator, FHE computing system and operating method thereof, aiming to improve the performance of FHE through the use of hardware accelerators

According to one or more embodiment of the present disclosure, an accelerated bootstrapping fully homomorphic encryption calculator includes a memory, a controller, a task scheduler, a plurality of processing units and a bus. The memory is configured to store a ciphertext structured as learning with errors over rings. The controller is configured to receive a first instruction to store the ciphertext in the memory, and generate a second instruction configured to perform a bootstrapping operation according to the ciphertext. The task scheduler is configured to receive the second instruction to generate a plurality of tasks and perform a scheduling of the plurality of tasks. The plurality of processing units is configured to decompose the ciphertext into the plurality of tasks, and perform a plurality of computations according to the scheduling to generate an intermediate result or a final result structured as learning with errors over rings. The bus is electrically connected to the memory, the controller, the task scheduler, and the plurality of processing units, and the bus is configured to transmit the ciphertext, the second instruction, and the final result.

According to one or more embodiment of the present disclosure, an accelerated bootstrapping fully homomorphic encryption system includes a host and a fully homomorphic encryption calculator. The host includes a storage device, a processor and a communication device. The storage device is configured to store a ciphertext structured as learning with errors over rings. The processor is configured to generate a first instruction for transmitting the ciphertext. The communication device is electrically connected to the processor and the storage device, and configured to transmit the ciphertext. The accelerated bootstrapping fully homomorphic encryption calculator includes a memory, a controller, a task scheduler, a plurality of processing units and a bus. The memory is configured to store a ciphertext structured as learning with errors over rings. The controller is configured to receive a first instruction to store the ciphertext in the memory, and generate a second instruction configured to perform a bootstrapping operation according to the ciphertext. The task scheduler is configured to receive the second instruction to generate a plurality of tasks and perform a scheduling of the plurality of tasks. The plurality of processing units is configured to decompose the ciphertext into the plurality of tasks, and perform a plurality of computations according to the scheduling to generate an intermediate result or a final result structured as learning with errors over rings. The bus is electrically connected to the memory, the controller, the task scheduler, and the plurality of processing units, and the bus is configured to transmit the ciphertext, the second instruction, and the final result.

According to one or more embodiment of the present disclosure, an operating method of an accelerated bootstrapping fully homomorphic encryption system includes the following steps: storing, by a storage device, a ciphertext structured as learning with errors over rings; generating, by a processor, a first instruction for transmitting the ciphertext; receiving, by a controller, the first instruction to store the ciphertext in a memory; generating, by a controller, a second instruction configured to perform a bootstrapping operation according to the ciphertext; receiving, by a task scheduler, the second instruction to generate a plurality of tasks and perform a scheduling of the plurality of tasks; and decomposing, by a plurality of processing units, the ciphertext into the plurality of tasks and performing a plurality of computations according to the scheduling to generate an intermediate result or a final result structured as learning with errors over rings.

In view of the above, the present disclosure proposes a hardware design based on RLWE ciphertext as the computational unit according to the structure of FHE ciphertext. This design not only provides excellent scalability but also offers high flexibility in the configuration of homomorphic parameters. Recently, due to the increasing adoption of functional bootstrapping, existing FHE calculators using current technologies are unable to support the growing size of homomorphic parameters. In this context, the accelerated bootstrapping FHE calculator, FHE computing system, and operating method proposed by the present disclosure may significantly enhance computation speed.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of an accelerated bootstrapping fully homomorphic encryption (FHE) computing system according to an embodiment of the present disclosure;

FIG. 2 is a data flow diagram of the bootstrapping operation according to an embodiment of the present disclosure;

FIG. 3 is a data flow diagram of the bootstrapping operation according to the prior art;

FIG. 4 is a flowchart of the operating method of the accelerated bootstrapping FHE computing system according to an embodiment of the present disclosure;

FIG. 5 is a comparison chart of execution time between the FHE calculator of the prior art and the FHE calculator of an embodiment of the present disclosure; and

FIG. 6 shows a relationship between the number of executions of the EvalFunc function and execution time across multiple processing units.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The computation of fully homomorphic encryption (FHE) increases the noise in the ciphertext, and the noise gradually accumulates with each operation. When the noise becomes too large, it may lead to decryption failure. In FHEW/TFHE, bootstrapping may remove the noise in the ciphertext, but the computation time for this process is 100 to 1000 times longer than other operations. In practical applications, bootstrapping typically accounts for more than 95% of the computation time. Therefore, the present disclosure proposes a FHE calculator, FHE computing system, and operating method specifically designed to accelerate the bootstrapping operation.

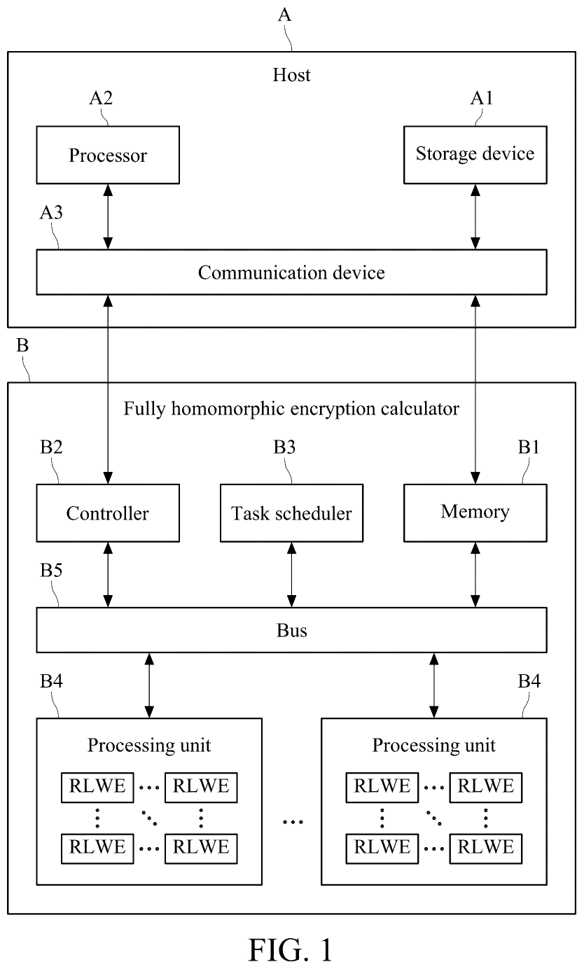

FIG. 1 is a block diagram of an accelerated bootstrapping FHE computing system according to an embodiment of the present disclosure. As shown in FIG. 1, the computing system includes a host A and a FHE calculator B, which are communicably connected to each other.

The host A includes a storage device A1, a processor A2, and a communication device A3. The host A is the machine held by the user, which can be a personal computer, server, or cloud platform.

The storage device A1 is configured to store ciphertext structured as Learning With Errors over Rings (RLWE) and the bootstrapping key used for computation during bootstrapping. The storage device A1 may be memory, a hard disk in the computer, or an external storage device connected to the computer. The present disclosure does not limit the specific type of the storage device A1.

The processor A2 is configured to generate a first instruction for transmitting the ciphertext. The processor A2 may be a central processing unit (CPU) or graphics processing unit (GPU). The first instruction includes starting addresses and lengths of the ciphertext and the bootstrapping key in the storage device A1.

In an embodiment, the storage device A1 further stores a decryption key configured to decrypt the ciphertext, and the processor A2 is further configured to generate the bootstrapping key according to the decryption key and the fully homomorphic encryption parameters (hereinafter referred to as homomorphic parameters).

The communication device A3 is electrically connected to the storage device A1 and the processor A2, and is configured to transmit the ciphertext to the FHE calculator B. In other words, the host A establishes a communication to the FHE calculator B through the communication device A3. The communication device A3 may be a Peripheral Component Interconnect Express (PCIE) interface.

The FHE calculator B includes a memory B1, a controller B2, a task scheduler B3, a plurality of processing units B4, and a bus B5. In an embodiment, the FHE calculator B may be implemented using a Field-Programmable Gate Array (FPGA), Application-Specific Integrated Circuit (ASIC), or system-on-a-chip (SoC).

The memory B1 is configured to store the ciphertext structured as Learning With Errors over Rings and the bootstrapping key. In an embodiment, the memory B1 may be implemented as flash memory, random access memory, non-volatile memory, hard disk, optical storage, magnetic storage, or a combination of the above examples.

The controller B2 is configured to receive the first instruction to transmit the ciphertext and the bootstrapping key from the storage device A1 via the communication device A3 to memory B1 for storage. The controller B2 is further configured to generate a second instruction for performing bootstrapping according to the ciphertext. In other words, the controller B2 is responsible for data and instruction transmission between the FHE calculator B and the host A, where the first instruction is configured to store the bootstrapping key in memory B1, and the second instruction is configured to inform the task scheduler B3 of the information required for bootstrapping. In an embodiment, the second instruction includes a start signal, the starting addresses and lengths of the ciphertext and the bootstrapping key in the memory B1, and a plurality of homomorphic parameters.

The task scheduler B3 is configured to receive the second instruction to generate a plurality of tasks and perform a scheduling on the plurality of tasks. The scheduling refers to task scheduler B3 allocating these tasks to a plurality of candidate units in an idle state among the plurality of processing units B4 and supervising the operation status of these candidate units. In an embodiment, the task scheduler B3 supports the concurrent processing of multiple bootstrapping operations. The task scheduler B3 checks whether a new second instruction has been received from the controller B2 and monitors the completion status of the executing second instruction.

Each processing unit B4 internally includes a plurality of computation modules RLWE, the input and output of each computation module are ciphertext structured as Learning With Errors over Rings. The present disclosure does not limit the number of processing units B4 or computation modules RLWE. In an embodiment, the hardware structure of each processing unit B4 is the same, and each has the same number of computation modules RLWE, which provides better performance and offers several advantages in hardware design and implementation, such as simplified hardware implementation, better workload balance, and higher cost/energy efficiency. In an embodiment, each processing unit B4 has a cache to temporarily store the input and output of the computation modules RLWE; however, if the cache capacity is insufficient, the computation results need to be stored back to the memory B1.

The processing unit B4 is configured to decompose the ciphertext into a plurality of tasks and perform a plurality of computations according to the schedule to generate intermediate results or final results structured as Learning With Errors over Rings. In an embodiment, these computations are performed in the following order: Gadget Decomposition for generating a plurality of tasks, Fast Fourier Transform (FFT), Inverse Fast Fourier Transform (IFFT), and the multiply-accumulate operation using the bootstrapping key on the plurality of intermediate results. Note that the inputs and outputs of these computations are based on ciphertext structured as Learning With Errors over Rings, with the same input size (dimension of Learning With Errors over Rings), and multiple computation modules RLWE are utilized for computing.

In an embodiment, the controller B2, the task scheduler B3, and all processing units B4 may be implemented as FPGA, ASIC, SoC, Arithmetic Logic Unit (ALU), Digital Signal Processor, microcomputer, programmable logic unit, or a combination of the above examples.

The bus B5 is electrically connected to the memory B1, the controller B2, the task scheduler B3, and all processing units B4. The bus B5 is configured to transmit the ciphertext, the second instruction, the intermediate result, and the final result. In an embodiment, the bus B5 may be a system-on-chip bus that supports communication among the modules of the FHE calculator B.

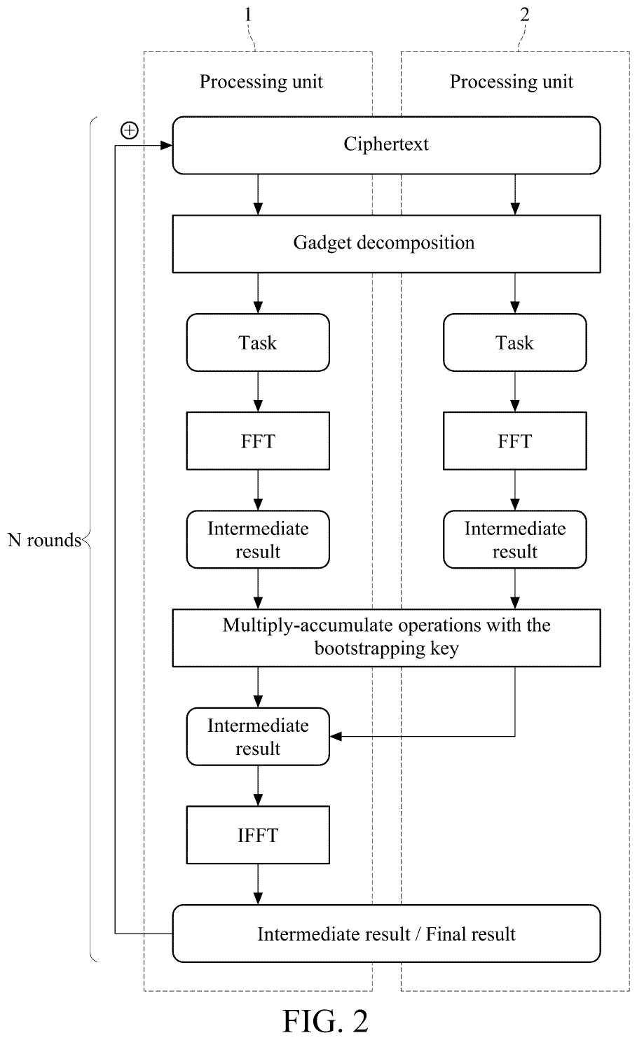

FIG. 2 is a data flow diagram of the bootstrapping operation according to an embodiment of the present disclosure, and the FHE calculator B shown in FIG. 1 is used to accelerate the computation. Before bootstrapping begins, the user may pre-determine homomorphic parameters such as the base, the modulus, or the number of task decompositions according to the FHE application scope. Additionally, the algebraic form of the ciphertext, represented by two polynomials, is transmitted to the memory B1.

As shown in FIG. 2, the bootstrapping operation will be performed in N rounds, with the process of each round as follows: the gadget decomposition decomposes the ciphertext into a plurality of tasks structured as Learning With Errors over Rings according to the base. The number of tasks is related to the numerical settings of the base, which in the example of FIG. 2 is two tasks, handled by the processing units 1 and 2, respectively. FFT converts all polynomials in each task from coefficient representation to point-value representation to generate the plurality of intermediate results, which are then subjected to multiply-accumulate operations with the bootstrapping key. The output is transformed back to the coefficient representation via IFFT. If it has not reached the Nth round, the intermediate result is added back to the previous ciphertext; if it has reached the final round, the final result is output.

As mentioned earlier, the task scheduler B3 monitors the operation of the candidate units. Specifically, the scheduling generated by the task scheduler B3 must ensure that the candidate units sequentially perform the gadget decomposition, FFT, multiply-accumulate operation using the bootstrapping key, and IFFT in the order shown in FIG. 2.

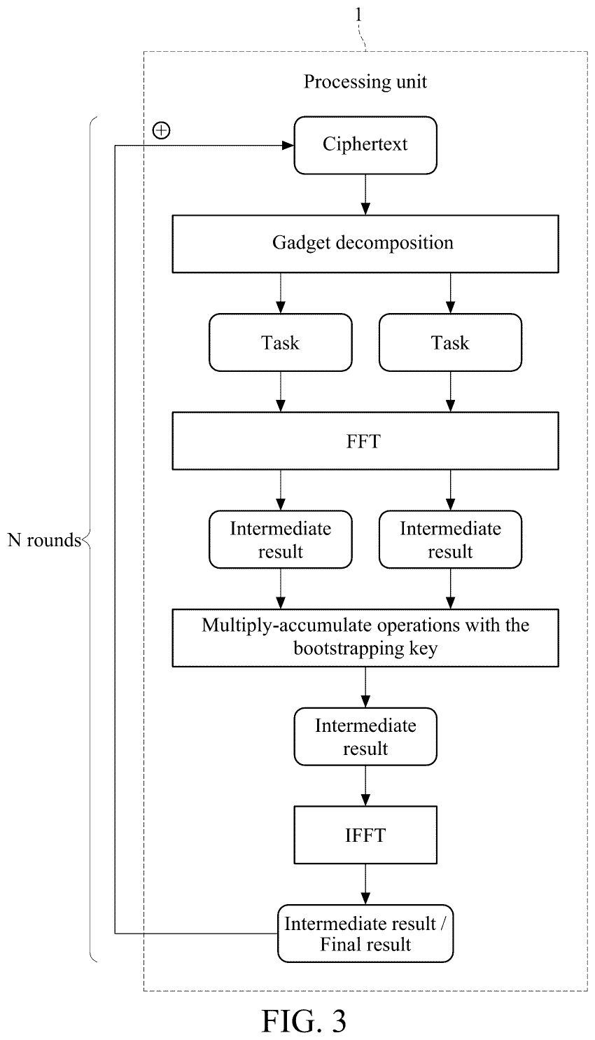

FIG. 3 is a data flow diagram of the bootstrapping operation according to the prior art. The FHE calculator of the prior art allocates all ciphertexts and intermediate results to a single processing unit 1 for computation. Therefore, when the value of homomorphic parameter increases to a value that cannot be processed by a single processing unit 1, the FHE calculator of the prior art becomes unusable. In contrast, the accelerated bootstrapping FHE calculator B of an embodiment of the present disclosure decomposes the ciphertext into a plurality of tasks, ensuring that each task and subsequent intermediate result remains as the ciphertext structured with Ring Learning With Errors (RLWE), and then assigns them to the plurality of processing units 1 and 2 for respective processing. Therefore, the present disclosure may better adapt to varying homomorphic parameters, and as the number of tasks increases, it can scale up by increasing the number of processing units. From a hardware perspective, compared to the FHE calculator of the prior art, the accelerated bootstrapping FHE calculator B in this embodiment introduces the design of the task scheduler B3 and a plurality of processing units B4, thereby enabling parallel independent task execution during the bootstrapping operation.

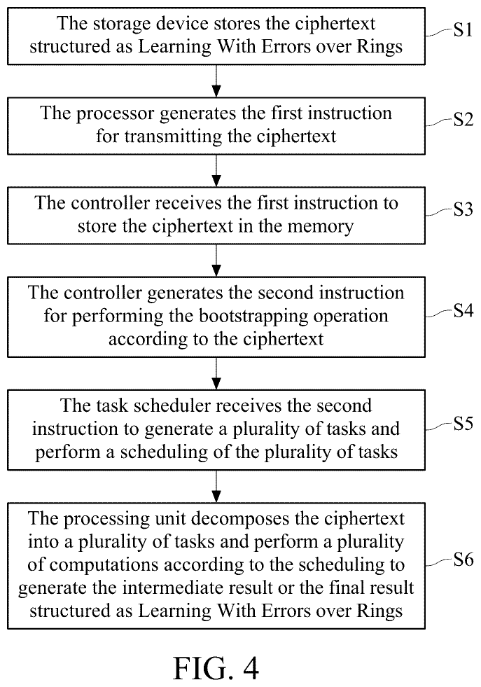

FIG. 4 is a flowchart of the operating method of the accelerated bootstrapping FHE computing system according to an embodiment of the present disclosure.

In step S1, the storage device A1 stores the ciphertext structured as Learning With Errors over Rings. In step S2, the processor A2 generates the first instruction for transmitting the ciphertext. In step S3, the controller B2 receives the first instruction to store the ciphertext in the memory B1. In the above process, the processor A2 informs the controller B2 to begin data transmission and provides the starting address and length of the data in the storage device A1. The controller B2 then transmits the data from the storage device A1 to the memory B1 through the communication device A3. In addition to the ciphertext, the first instruction is also configured to transmit the bootstrapping key and the homomorphic parameters.

In step S4, the controller B2 generates the second instruction for performing the bootstrapping operation according to the ciphertext. In step S5, the task scheduler B3 receives the second instruction to generate a plurality of tasks and perform a scheduling of the plurality of tasks. In step S6, the processing unit B4 decomposes the ciphertext into a plurality of tasks and perform a plurality of computations according to the scheduling to generate the intermediate result or the final result structured as Learning With Errors over Rings. In the above process, the controller B2 informs the task scheduler B3 of the starting addresses, lengths of the ciphertext and the bootstrapping key in the memory B1, and all the homomorphic parameter values. The task scheduler B3 then conveys the information to the processing unit B4 to initiate the bootstrapping operation.

Please refer to FIG. 1, FIG. 2, and FIG. 4 together. Regarding the process of generating the intermediate result in step S6, the task scheduler B3 selects a plurality of candidate units in an idle state among the plurality of processing units B4 and assigns the tasks generated in step S5 to these candidate units, while ensuring that each candidate unit follows the execution sequence of FFT, IFFT, and the multiply-accumulate operation using the bootstrapping key on the plurality of intermediate results.

When assigning tasks, the task scheduler B3 prioritizes the processing unit B4 in the idle state. If all processing units B4 are busy, the task scheduler B3 prioritizes those units with the most available computation modules to achieve load balancing. In an embodiment, as shown in FIG. 2, each task generated by gadget decomposition is executed on the same processing unit B4 for all subsequent operations to improve cache hit rates. If there are enough idle computation modules within a single processing unit B4, the task scheduler B3 may also assign a plurality of tasks to be executed on the same processing unit B4.

After the final result is generated in step S6, the process includes the following steps: the task scheduler B3 informs the controller B2 that the plurality of operations is complete, the controller B2 informs the processor A2 of the starting address and length of the final result in the memory B1, the communication device A3 transmits the final result to the storage device A1, and the processor A2 informs the controller B2 that the bootstrapping operation is complete.

In an embodiment, the accelerated bootstrapping FHE calculator B of the present disclosure is simulated by a Graphic Processing Unit (GPU). The test environment is as follows: multiple NVIDIA RTX 4090 GPUs (24 GB VRAM) were used. The homomorphic encryption library is the open-source OpenFHE, version 1.0.4. The compiler uses the default setting and 64-bit integers. The host A is a server (hardware), the processor A2 is an AMD Ryzen Threadripper 3970X CPU (32 cores, 64 threads), the storage device A1 is 128 GB memory, and the operating system is Ubuntu 22.04.2 LTS as. As a control group, parallel computing is implemented on the CPU side using OpenMP, with each thread performing one bootstrapping operation.

The simulation results are shown in Table 1, listing the execution times for FHEW/TFHE bootstrapping under different configurations. These configurations include using 1 CPU thread (CPU IT), 64 CPU threads (CPU 64T), and GPU simulations (including 1 GPU and 8 GPUs).

The functions listed in Table 1 are all functions supported by the FHEW/TFHE of the OpenFHE library, and their internal implementations are based on bootstrapping, which can be considered as an extension of bootstrapping. Among them, EvalFunc, EvalFloor, EvalSign, and EvalDecomp are extensions of functional bootstrapping, where the parameter sizes of these functions far exceed that of general bootstrapping (such as EvalBinGate). As a result, the FHE calculator of the prior art cannot handle such large parameters. In comparison, the accelerated bootstrapping FHE calculator B, according to an embodiment of the present disclosure, may achieve a speedup of 600 to 700 times compared to a single-threaded CPU. As the number of GPUs (equivalent to the number of calculators) increases, the speedup can reach up to a thousand times.

Table 1, where “n” is the dimension of the polynomial in the ciphertext structured as Learning with Errors (LWE), “q” is the modulus of the numbers in the LWE ciphertext, “N” is the dimension of the polynomial in RLWE ciphertext, “Q” is the modulus of the numbers in the RLWE ciphertext, and “Bg” is the base used in gadget decomposition.

Execution Time (millisecond/ciphertext)

| | EvalBinGate | | EvalFunc | | EvalFloor | | EvalSign | | EvalDecomp | |
|---|---|---|---|---|---|---|---|---|---|---|
| n | 512 | | 1305 | | 1305 | | 1305 | | 1305 | |
| q | 1024 | | 2048 | | 2048 | | 4096 | | 4096 | |
| log₂Q | 27 | | 54 | | 27 | | 54 | | 54 | |
| N | 1024 | | 2048 | | 1024 | | 2048 | | 2048 | |
| B_{g} | 27 | | 227 | | 25 | | 218 | | 218 | |
| CPU 1T | 153 | (1X) | 1037 | (1X) | 1158 | (1X) | 3424 | (1X) | 4092 | (1X) |
| CPU 64T | 4.3 | (36X | 28.5 | (36X) | 34.6 | (34X) | 93.6 | (37X) | 112.6 | (36X) |
| 1 GPU | 0.23 | (665X) | 1.59 | (652X) | 1.68 | (689X) | 4.99 | (686X) | 6.03 | (679X) |
| 8 GPU | 0.04 | (3825X) | 0.23 | (4509X) | 0.23 | (5035X) | 0.69 | (4962X) | 0.88 | (4650X) |

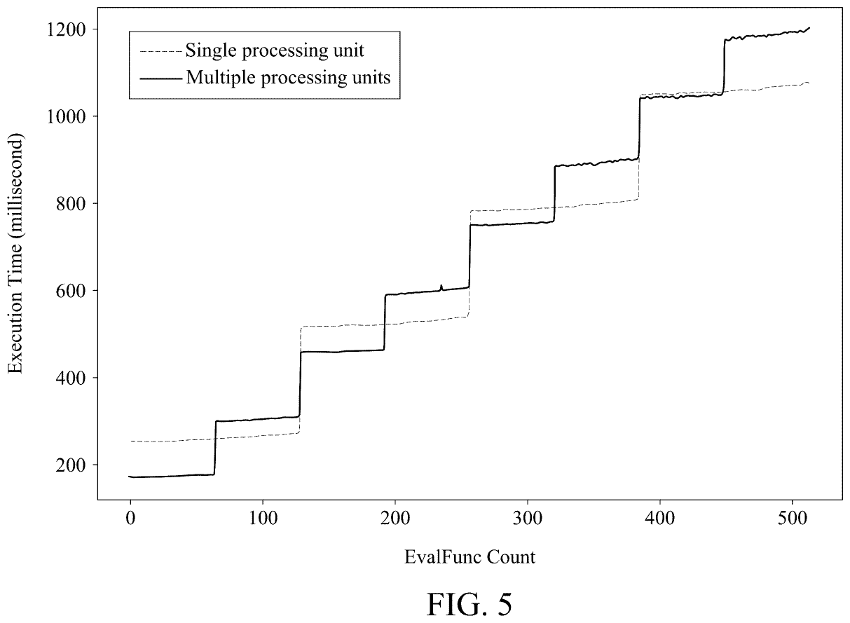

FIG. 5 shows a comparison of the execution time for the EvalFunc function between a single processing unit and multiple processing units, with a base B_{g} of 2²⁷. As shown in FIG. 5, when the number of EvalFunc executions varies, the execution speed of the single processing unit (prior art) and the multiple processing units (the present disclosure) differ. Specifically, the present disclosure is more than twice as fast as the prior art when the number of EvalFunc executions is less than 64.

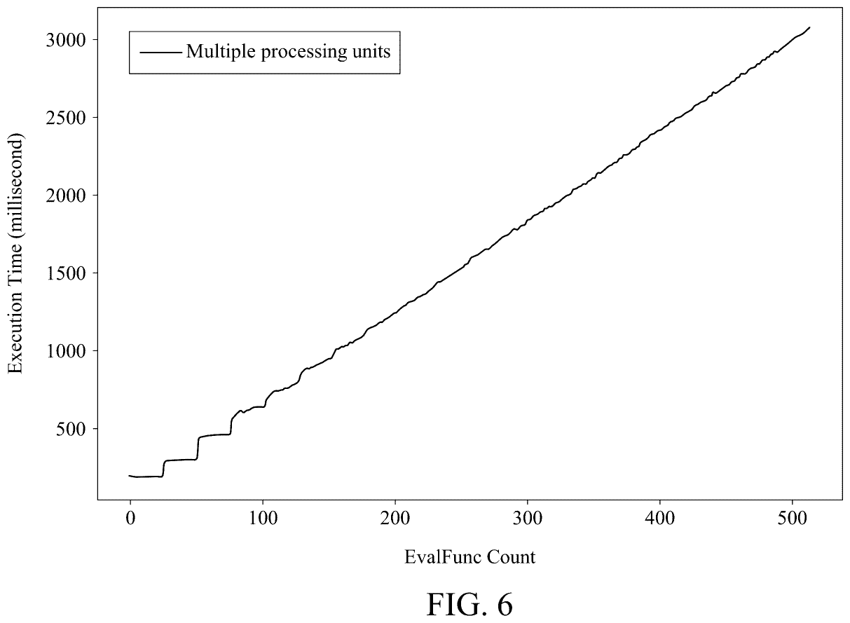

FIG. 6 shows the relationship between the number of EvalFunc executions and execution time in the multiple processing unit, with a base B_{g} of 2₉. The FHE calculator of the prior art cannot support such a small base value because a single processing unit cannot handle all the data in the bootstrapping process. In contrast, the present disclosure supports this homomorphic parameter setting by decomposing the ciphertext into a plurality of tasks. Note that in FIG. 5 and FIG. 6, only the base values differ, while the other homomorphic parameters are the same (n=1305, q=2048, N=2048, Q=25).

In view of the above, the present disclosure proposes a hardware design based on RLWE ciphertext as the computational unit according to the structure of FHE ciphertext. This design not only provides excellent scalability but also offers high flexibility in the configuration of homomorphic parameters. Recently, due to the increasing adoption of functional bootstrapping, existing FHE calculators using current technologies are unable to support the growing size of homomorphic parameters. In this context, the accelerated bootstrapping FHE calculator, FHE computing system, and operating method proposed by the present disclosure may significantly enhance computation speed.

What is claimed is:

1. An accelerated bootstrapping fully homomorphic encryption calculator, comprising:
a memory configured to store a ciphertext structured as learning with errors over rings;
a controller configured to receive a first instruction to store the ciphertext into the memory, and generate a second instruction configured to perform a bootstrapping operation according to the ciphertext;
a task scheduler configured to receive the second instruction to generate a plurality of tasks and perform a scheduling of the plurality of tasks;
a plurality of processing units configured to decompose the ciphertext into the plurality of tasks, and perform a plurality of computations according to the scheduling to generate an intermediate result or a final result structured as learning with errors over rings; and
a bus electrically connected to the memory, the controller, the task scheduler, and the plurality of processing units, wherein the bus is configured to transmit the ciphertext, the second instruction, and the final result.

2. The accelerated bootstrapping fully homomorphic encryption calculator of claim 1, wherein the memory is further configured to store a bootstrapping key, and the plurality of computations comprises: a gadget decomposition for generating the plurality of tasks, a fast Fourier transform, an inverse fast Fourier transform, and a multiply-accumulate operations using the bootstrapping key on the intermediate result.

3. An accelerated bootstrapping fully homomorphic encryption system, comprising:
a host, comprising:
a storage device configured to store a ciphertext structured as learning with errors over rings;
a processor configured to generate a first instruction for transmitting the ciphertext; and
a communication device electrically connected to the processor and the storage device, and configured to transmit the ciphertext; and
a fully homomorphic encryption calculator, comprising:
a memory configured to store a ciphertext structured as learning with errors over rings;
a controller configured to receive a first instruction to store the ciphertext into the memory, and generate a second instruction configured to perform a bootstrapping operation according to the ciphertext;
a task scheduler configured to receive the second instruction to generate a plurality of tasks and perform a scheduling of the plurality of tasks;
a plurality of processing units configured to decompose the ciphertext into the plurality of tasks, and perform a plurality of computations according to the scheduling to generate an intermediate result or a final result structured as learning with errors over rings; and
a bus electrically connected to the memory, the controller, the task scheduler, and the plurality of processing units, wherein the bus is configured to transmit the ciphertext, the second instruction, and the final result.

4. The accelerated bootstrapping fully homomorphic encryption system of claim 3, wherein the storage device and the memory are further configured to store a bootstrapping key, and the plurality of computations comprises: a gadget decomposition for generating the plurality of tasks, a fast Fourier transform, an inverse fast Fourier transform, and a multiply-accumulate operation using the bootstrapping key on the intermediate result.

5. The accelerated bootstrapping fully homomorphic encryption system of claim 4, wherein the storage device is further configured to store a decryption key for decrypting the ciphertext, and the processor is further configured to generate the decryption key according to the decryption key and homomorphic parameters.

6. An operating method of an accelerated bootstrapping fully homomorphic encryption system, comprising:
storing, by a storage device, a ciphertext structured as learning with errors over rings;
generating, by a processor, a first instruction for transmitting the ciphertext;
receiving, by a controller, the first instruction to store the ciphertext in a memory;
generating, by the controller, a second instruction configured to perform a bootstrapping operation according to the ciphertext;
receiving, by a task scheduler, the second instruction to generate a plurality of tasks and perform a scheduling of the plurality of tasks; and
decomposing, by a plurality of processing units, the ciphertext into the plurality of tasks and performing a plurality of computations according to the scheduling to generate an intermediate result or a final result structured as learning with errors over rings.

7. The operating method of the accelerated bootstrapping fully homomorphic encryption system of claim 6, further comprising:
storing, by the storage device, a bootstrapping key, wherein the first instruction is further configured to store the bootstrapping key in the memory, and the plurality of computations comprises: a gadget decomposition for generating the plurality of tasks, a fast Fourier transform, an inverse fast Fourier transform, and a multiply-accumulate operation using the bootstrapping key on the intermediate result.

8. The operating method of the accelerated bootstrapping fully homomorphic encryption system of claim 7, wherein the first instruction comprises a first starting address and a first length of the ciphertext and the bootstrapping key in the storage device, and the second instruction comprises a second starting address, a second length of the ciphertext and the bootstrapping key in the memory, and a plurality of homomorphic parameters.

9. The operating method of the accelerated bootstrapping fully homomorphic encryption system of claim 7, wherein performing the plurality of computations according to the scheduling to generate the intermediate result structured as learning with errors over rings comprises:
selecting a plurality of candidate units from the plurality of processing units that are in an idle state; and
assigning the plurality of tasks to the candidate units and ensuring that each candidate unit executes each of the plurality of tasks in a sequence of: the fast Fourier transform, the inverse fast Fourier transform, and the multiply-accumulate operation using the bootstrapping key on the intermediate result.

10. The operating method of the accelerated bootstrapping fully homomorphic encryption system of claim 6, further comprising:
informing, by the task scheduler, the controller that the plurality of computations is complete after performing the plurality of computations according to the scheduling to generate the final result structured as learning with errors over rings;
informing, by the controller, the processor of a starting address and a length of the final result in the memory;
transmitting, by a communication device, the final result to the storage device; and
informing, by the processor, the controller that the bootstrapping operation is complete.
